(19) United States
(12) Patent Application Publication
(10) Pub. No.: US 2017/0053525 A1
(43) Pub. Date: Feb. 23, 2017

(54) ALARM MONITORING SYSTEM AND METHOD

(71) Applicant: Carrier Corporation, Farmington, CT (US)

(72) Inventors: Richard Desmarais, Londonderry, NH (US); Froberto Faller, Beverly, MA (US); Peter Nunes, Amesbury, MA (US)

(21) Appl. No.: 15/308,186

(22) PCT Filed: May 6, 2015
(86) PCT No.: PCT/US2015/029430

§ 371 Date: Nov. 1, 2016

Related U.S. Application Data
(60) Provisional application No. 61/993,800, filed on May 15, 2014.

(51) Int. Cl. G08B 29/02

(52) U.S. Cl. CPC G08B 29/02

(57) ABSTRACT

An alarm monitoring device (10) includes a portable monitor (100). A user interface (102) and a display screen (104) are coupled thereto. A sensor (108) and a memory (112) are disposed within the monitor. A processor (110) is disposed within the monitor and in electric communication with the user interface, display, sensor and memory. The processor has program instructions to receive data from the sensor and display on the display screen time remaining until an alarm is triggered.

### CROSS-REFERENCE TO RELATED APPLICATIONS

This application claims the benefit of and priority to U.S. Provisional Patent Application No. 61/993,800, filed on May 15, 2014, the entire contents of which are incorporated herein by reference.

### BACKGROUND OF THE INVENTION

1. Field of the Invention

The present disclosure relates generally to alarms, and more particularly to monitors to configured to display the time remaining prior to an alarm being triggered.

2. Description of Related Art

Many pharmaceutical substances are temperature sensitive, and will undergo chemical alteration, will lose potency or have a diminished shelf life if exposed to temperatures over or under the manufacturers' required temperature storage range. Administering a drug that has been chemically altered or that has lost potency will typically not have the anticipated efficacy.

Pharmaceutical companies want to place consigned inventory in locations where it will be effective, used and therefore sold. Typically consigned inventory is placed on the shelves in hospitals and a local company representative manages that inventory. As such, pharmaceutical companies are reluctant to relocate aging, unused inventory to another customer facility or back to a central warehouse as this process places excess temperature stress on the inventory. Not knowing how much temperature stress the inventory item may still experience and remain viable can prevent field representatives from making informed choices as to whether to relocate inventory.

Such conventional methods and systems have generally been considered satisfactory for their intended purpose. However, there is still a need in the art for improved alarm monitoring devices and methods. The present disclosure provides a solution for this need.

### SUMMARY OF THE INVENTION

An alarm monitoring device includes a portable monitor. The portable monitor includes a user interface and a display coupled thereto. A sensor is disposed within the monitor. A processor is disposed within the monitor and in electric communication with the user interface, display and sensor. A memory disposed within the monitor is in communication with the processor. The processor having program instructions to receive data from the sensor and display the time remaining until an alarm is triggered.

The memory can also include program instructions to store a predetermined condition defined by the monitor being exposed to an ambient condition for a duration of time. The processor can be programmed to divide the duration of time into equal time segments such that the time remaining can be defined by a sum of equal time segments remaining prior to the alarm being triggered. In certain embodiments, the time remaining can be displayed as a percentage of the duration of time until the alarm is triggered.

The user interface can include an activation button operatively connected to the processor to display the time remaining on the display screen. In certain embodiments, a triggered alarm may be continuously displayed. It is also contemplated that the device may include more than one alarm wherein the time remaining for each alarm can be displayed.

A method for monitoring time remaining for an alarm includes sensing a condition by a sensor disposed within a monitor and displaying on a display coupled to the monitor time remaining prior to an alarm being triggered. The method can further include inputting a predetermined condition into a memory of the monitor and activating the monitor by a user interface coupled to the monitor. The duration of time of the predetermined condition may also be divided into equal time segments by the processor such that the time remaining is defined by a sum of the equal time segments remaining prior to the alarm being triggered. At a later time interval a user may initial time remaining update such that the steps of sensing, initiating and displaying may be repeated until the alarm has triggered. In certain embodiments, more than one predetermined condition may be inputted into the memory. In this instance, the time remaining for each alarm can be displayed by cycling through the status for each alarm.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a top plan view of an exemplary embodiment of a monitor of an alarm monitoring system constructed in accordance with the present disclosure, showing a user interface and a display screen;

FIG. 2 is a schematic view of the monitor of FIG. 1;

FIG. 3 is a plan view of the display screen of the monitor of FIG. 1 showing the status of the monitor once activated;

FIGS. 4a-4e are plan views of the display screen of the monitor of FIG. 1 showing the time remaining for a first and second alarm at a first time interval;

FIGS. 5a-5e are plan views of the display screen of the monitor of FIG. 1 showing the time remaining for the first alarm and time accrued against the second alarm at a second time interval;

FIGS. 6a-6d are plan views of the display screen of the monitor of FIG. 1 showing the time remaining for the first alarm and status of the second alarm at a third time interval; and

FIG. 7 is a flow chart illustrating an exemplary embodiment of method steps for displaying the time remaining of the alarm monitoring system in accordance with the present disclosure.

### DETAILED DESCRIPTION OF THE PREFERRED EMBODIMENTS

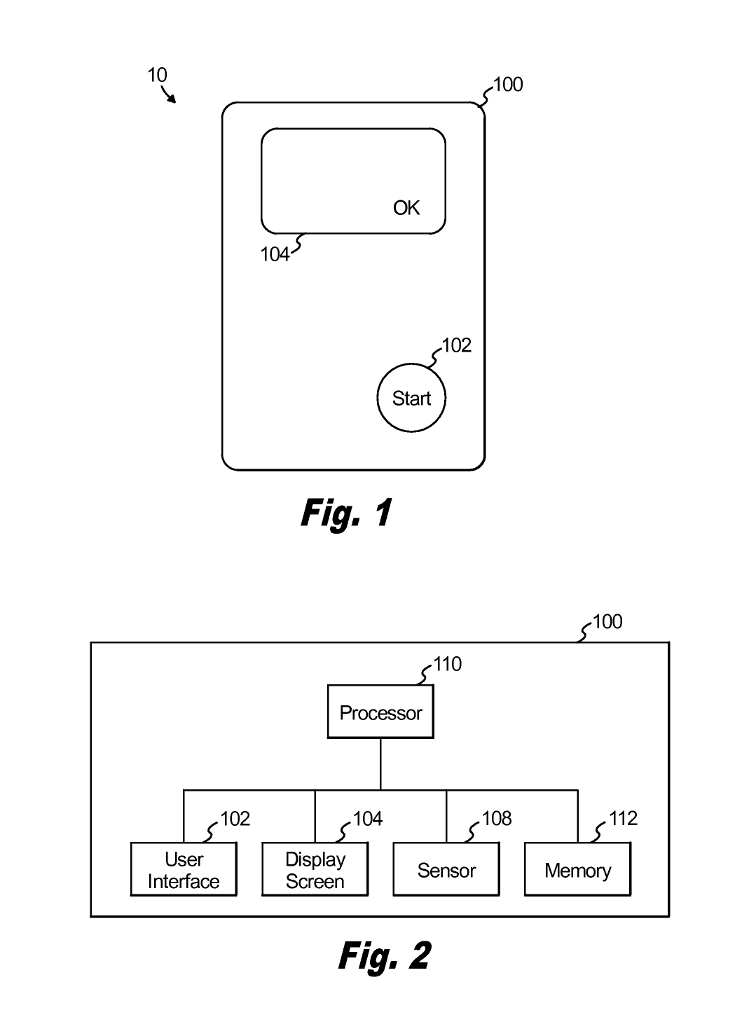

Reference will now be made to the drawings wherein like reference numerals identify similar structural features or aspects of the subject disclosure. For purposes of explanation and illustration, and not limitation, a partial view of an exemplary embodiment of the alarm monitoring device in accordance with the disclosure is shown in FIG. 1 and is designated generally by reference character 10. Other embodiments of alarm monitoring devices in accordance with the disclosure, or aspects thereof, are provided in FIGS. 2-7, as will be described. The alarm monitoring device 10, as shown in FIG. 1, includes a portable monitor 100 with a user interface 102 and display screen 104 coupled thereto. The display screen 104 can be any type of display such as but not limited to a liquid-crystal display (LCD) and a light-emitting diode (LED). The portable monitor can be in the vicinity of a pharmaceutical substance being monitored. For example, the monitor can be placed on the shelving of a hospital where the substances are located or the monitor can be placed within storage containers used for shipping the substances. A sensor 108 is disposed within the monitor 100 to sense ambient conditions of which the monitor 100 is exposed. In certain embodiments, sensor 108 can be disposed external to monitor 100. A processor 110 is disposed within the monitor 100 and in electric communication with the user interface 102, display screen 104 and sensor 108. Monitor 100 can further include either an internal or external power source such that monitor 100 is active for the duration of use.

At least one predetermined condition is stored within a memory 112 of the monitor 100. In embodiments, memory 112 may be disposed external to monitor 100. Once the predetermined condition is met, the monitor 100 displays that an alarm is triggered. More specifically, the predetermined condition is defined by the sensor 108 of the monitor 100 being exposed to an ambient condition for a duration of time. The predetermined condition, for example, can include a minimum temperature and a duration such as number of weeks. Once the sensor 108 is exposed to any temperature greater than the minimum for the designated number of weeks, the alarm will trigger.

The processor 110 is adapted to receive data from the sensor 108 and display on the display screen 104 the time remaining until an alarm is triggered. In other words, the display screen 104 will show the amount of time left before the predetermined condition is met. To achieve this, the processor 110 is programmed to divide the duration of time of the predetermined condition into ten equal time segments. Using the previous example, if the minimum temperature is 8° C. with a duration of 60 weeks, and the sensor 108 has been exposed to temperatures greater than 8° C. for 30 weeks, the display screen 104 will show that 5 time segments or 50% of time remains prior to the alarm being triggered. In certain embodiments, the time remaining is defined by a sum of the equal time segments remaining. For example, a 1 and 4 may be displayed on the display screen indicating that 5 time segments are remaining. In certain embodiments, a percentage may be shown to indicate the time remaining. Any other suitable display to notify the user of the time remaining can be used. Displaying the time remaining in this manner, prior to the condition being met and the alarm being triggered, gives notice to the user of the quality and efficacy of the substances within the vicinity of the device 10. Moreover, as the memory 112 may be programmed with more than one predetermined condition, the device 10 can monitor several varying substances at one time and/or can monitor a single substance on multiple criteria at one time.

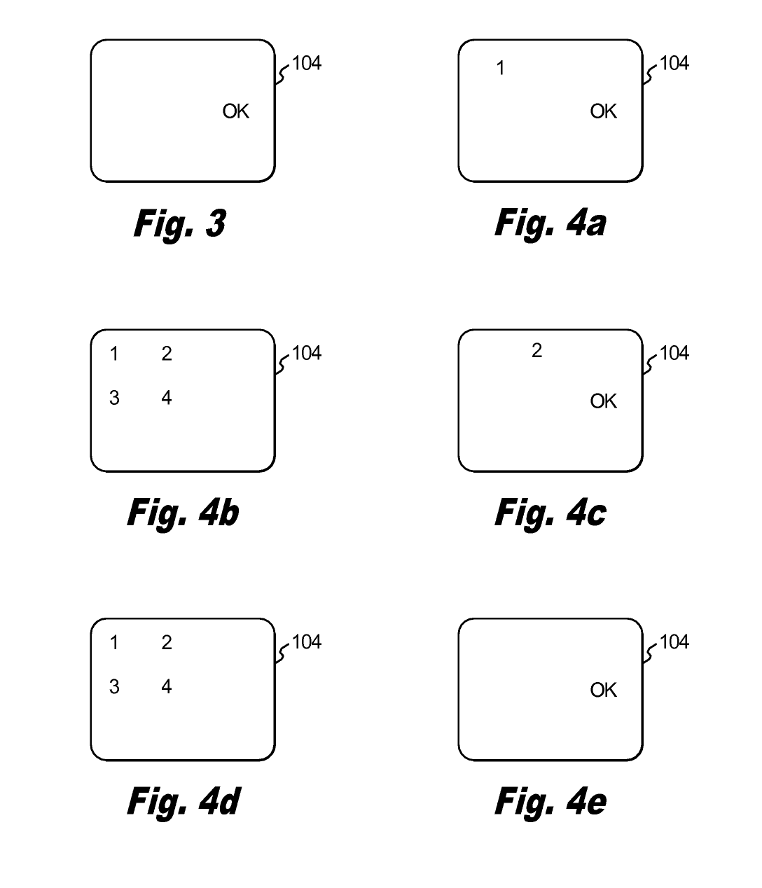

FIGS. 3-6d illustrate a specific example of the alarm monitoring system. In this example, the memory 112 is pre-programmed with two predetermined conditions that once met will indicate the respective alarm has triggered. The first condition includes a maximum temperature of negative 18° C. for a duration of 48 weeks. If the monitor 100 is exposed to temperatures less than −18° C. (<−18° C.) for 48 weeks the first condition is satisfied and the first alarm is triggered. The second condition includes a minimum temperature of 8° C. for 65 weeks. If the monitor 100 is exposed to temperatures greater than 8° C. (>8° C.) for 65 weeks, the second condition is satisfied and the second alarm is triggered. The two predetermined conditions may relate to one substance being monitored or may include the desired temperature ranges for several substances.

At room temperature, 22° C., the first condition will never accrue any time against the first alarm. The second condition will begin accruing time as soon as the monitor is activated. Once programmed, the processor 110 divides the two durations into ten equal time segments. For the first condition, 4.8 weeks and for the second condition 6.5 weeks.

After the monitor 100 is positioned as desired in the vicinity of a pharmaceutical substance, the monitor 100 is activated by the user interface 102, which can be a button on the monitor 100. For example, a user may press a start button, as shown in FIG. 1, to activate the monitor 100. FIG. 3 shows the display screen 104 immediately following the monitor 100 being activated. The display screen 104 simply shows “OK” to indicate no alarm has triggered. If a user momentarily again pushes the start button 102 since no time has accrued and no alarm has triggered the monitor 100 will display the following screens. As shown in FIG. 4a, the number for the first condition “1” is displayed with an “OK”. The OK signifies that the first alarm has not triggered. Next, as shown in FIG. 4b, the number of time segments remaining for the first condition will be displayed. The numbers one through four are read as ten time segments by adding all the visible number icons (1, 2, 3 & 4) together. This ten represents ten, 4.8 week segments are still remaining. In other words, 48 weeks or 100% of the first alarm time is remaining. Next, as shown in FIG. 4c, the number for the second condition “2” is displayed with an “OK”. Again, since the second alarm has not yet triggered, FIG. 4d, shows the number of time segments remaining. In this case, ten, 6.5 week segments are still remaining. In other words, 65 weeks or 100% of the second alarm time is remaining. The display screen 104 will then return to displaying the monitor status of “OK” as shown in FIG. 4e because neither alarm is triggered. As will be understood by those skilled in the art, displaying the time remaining using numbers 1, 2, 3, 4 for 10 time segments is just one method. The time remaining may be displayed as a percentage. Other suitable means for indicating the time remaining before an alarm has triggered may also be used.

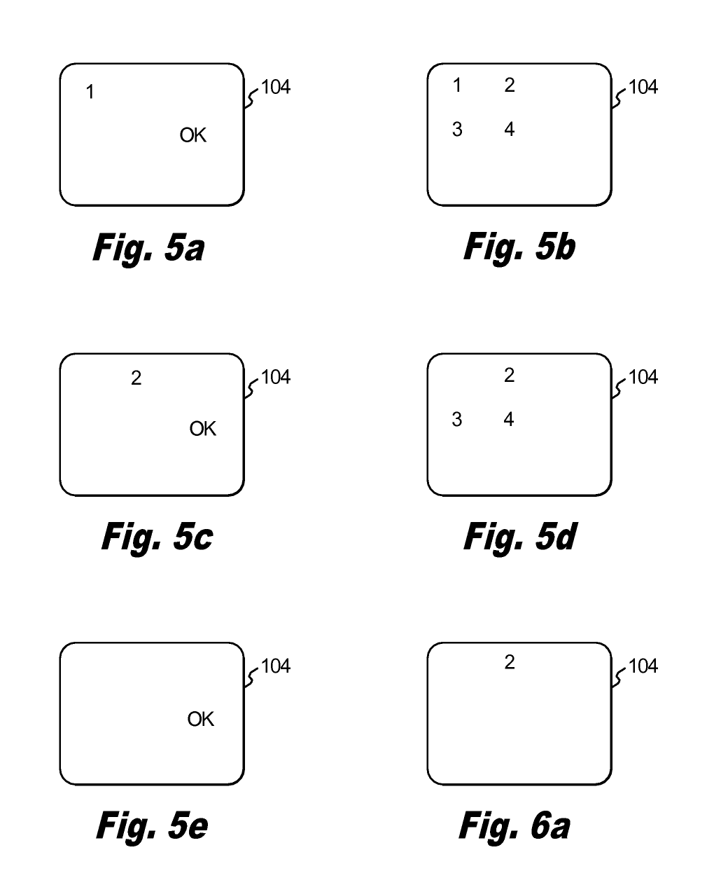

Assuming the monitor remains at a constant room temperature (22° C.) for 7 weeks, neither alarm will trigger. However, the second condition will begin accruing time against the duration specified in the predetermined condition. Since 7 weeks is greater than one 6.5 week time segment, the second condition is less one time segment. FIGS. 5a-5e illustrate the display screen 104 when the start button 102 is pressed at this time interval. As shown in FIG. 5a, the first condition is still untriggered and is displayed with a “1” indicating the first condition and “OK” indicating the first alarm has not triggered. This will display for one second. Next, the number of time segments remaining for the first alarm is displayed (FIG. 5b). Since no time has accrued against the first condition, all ten segments are displayed. The display will then continue to cycle to the next condition. The second condition is still untriggered and as such, the display screen 104 will show a “2” indicating the second condition and “OK” indicating the second alarm has not triggered (FIG. 5c). FIG. 5d shows the next screen on the display indicating that one of the ten time segments was accrued. The sum of the numbers displayed “2, 3, & 4” indicate that nine time segments remain or, in other words, 90%. The display screen 104 will then return to displaying the monitor status of “OK” because neither alarm is triggered (FIG. 5e).

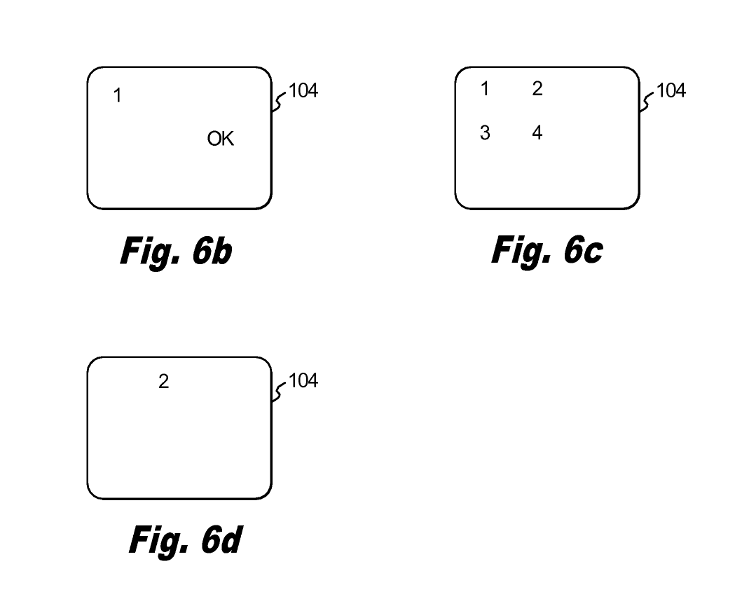

FIGS. 6a-6d assume that the monitor 100 is held at room temperature for greater than 65 weeks. At this point, the second alarm is triggered while no time will have accrued against the first condition. At the time the second alarm triggers the display screen 104 will show the number “2” continuously indicating that the second condition was met and the second alarm has triggered (FIG. 6a). When the user presses the start button 102, the display screen 104 will show that the first alarm is “OK” (FIG. 6b) and that all time segments remain (FIG. 6c). The display screen will return to display the status of the second alarm indicating that this alarm has triggered, as shown in FIG. 6d. As will be noted, since the second condition has been met and the second alarm has triggered, the display screen 104 no longer cycles through the sequence of the second alarm since there are zero time segments remaining to display. The previous example has been shown and described wherein the user activates the monitor through the user interface to display the time remaining. In certain embodiments, memory may be preprogrammed to store and cycle through the time remaining for each alarm at specified time intervals.

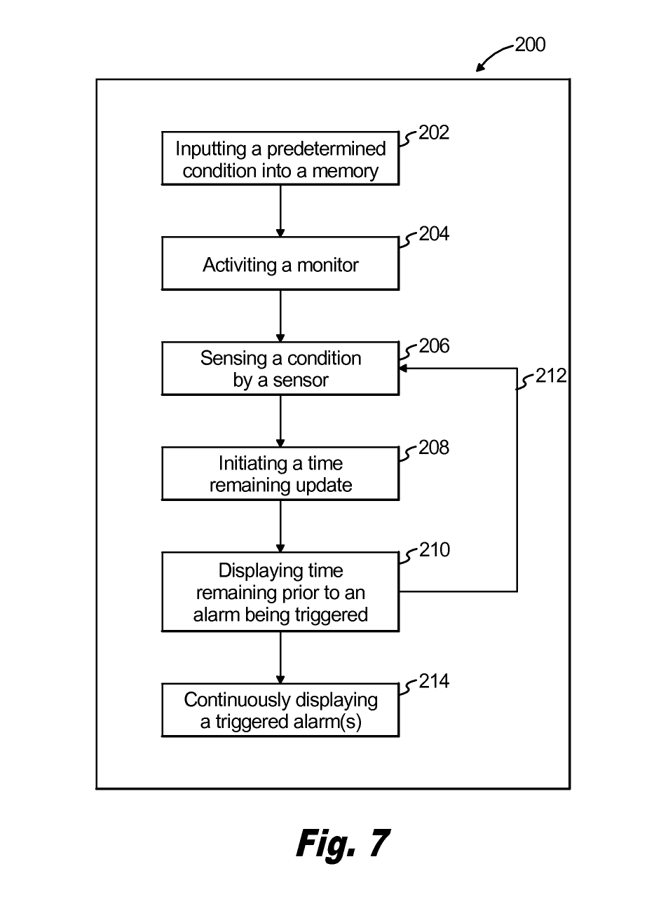

With reference to FIG. 7, a method is described for displaying the time remaining until an alarm has triggered using the alarm monitoring system described above. Step 202 of the method 200 includes inputting a predetermined condition into a memory, e.g., memory 112, of a monitor, e.g., monitor 100. Once the predetermined condition is inputted, a user activates the monitor at step 204. The user activates the monitor via a user interface, e.g., user interface 102, coupled to the monitor. A sensor, e.g., sensor 108, disposed within the monitor begins step 206 by sensing ambient conditions to compare to the predetermined condition. At a later time interval, the user initiates a time remaining update, step 208, by the user interface. A display screen, e.g., display screen 104, coupled to the monitor displays the time remaining prior to the alarm being triggered at step 210. After displaying the time remaining, the steps of sensing, initiating and displaying are repeated at step 212, as needed, to continually receive status of the predetermined condition. Once a condition has been met and the alarm is triggered, the display screen continuously displays an indicator of the triggered alarm at step 214. The method 200 has been shown and described with one predetermined condition inputted into the memory of the monitor, however, a plurality of conditions can be stored into the memory. In this instance, one the user initiates a time remaining update the display screen cycles through the status for each condition, displaying the time remaining until each alarm is triggered.

The methods and systems of the present disclosure, as described above and shown in the drawings, provide for an alarm monitoring system with superior properties including displaying the time remaining until an alarm is triggered. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. An alarm monitoring device, comprising:
a portable monitor;
a user interface coupled to the monitor;
a display coupled to the monitor;
a sensor disposed within the monitor;
a memory disposed within the monitor; and
a processor disposed within the monitor and in electric communication with the user interface, display, sensor and memory having program instructions to receive data from the sensor to show on the display time remaining until an alarm is triggered.

2. The alarm monitoring device of claim 1, wherein the memory has program instructions to store a predetermined condition defined by the monitor being exposed to an ambient condition for a duration of time.

3. The alarm monitoring device of claim 2, wherein the processor is programmed to divide the duration of time into equal time segments.

4. The alarm monitoring device of claim 3, wherein the time remaining is defined by a sum of equal time segments remaining prior to the alarm being triggered.

5. The alarm monitoring device of claim 1, wherein the user interface includes an activation button operatively connected to the processor to display the time remaining on the display screen.

6. The alarm monitoring device of claim 1, wherein a triggered alarm is continuously displayed on the display screen.

7. The alarm monitoring device of claim 1, wherein the device includes more than one alarm.

8. The alarm monitoring device of claim 7, wherein the time remaining for each alarm is shown on the display.

9. The alarm monitoring device of claim 1, wherein the time remaining is displayed as a percentage of the duration of time until the alarm is triggered.

10. The alarm monitoring device of claim 1, wherein the sensor is configured to sense an ambient temperature.

11. The alarm monitoring device of claim 1, wherein the device is positioned proximate a perishable good.

12. A method of monitoring time remaining for an alarm, comprising:
a) sensing a condition by a sensor disposed within a monitor; and
b) displaying on a display coupled to the monitor time remaining prior to an alarm being triggered.

13. The method of claim 12, further comprising inputting a predetermined condition into a memory of the monitor.

14. The method of claim 12, further comprising activating the monitor by a user interface coupled to the monitor.

15. The method of claim 13, wherein the predetermined condition is defined by the monitor being exposed to an ambient condition for a duration of time.

16. The method of claim 15, further comprising dividing the duration of time into equal time segments by the processor such that the time remaining is defined by a sum of the equal time segments remaining prior to the alarm being triggered.

17. The method of claim 12, further comprising initiating a time remaining update at a later time interval.

18. The method of claim 17, further comprising repeating the steps of sensing, initiating and displaying until the alarm has triggered.

19. The method of claim 13, wherein more than one predetermined condition is inputted into the memory.

20. The method of claim 19, wherein the step of displaying includes cycling through the time remaining for each alarm.

21. The method of claim 12, wherein the step of displaying includes the display returning to a home state.

22. The method of claim 12, wherein the step of displaying includes continuously displaying a triggered alarm.

23. The method of claim 12, wherein the step of sensing includes sensing an ambient temperature.
